(19) United States
(12) Patent Application Publication
(10) Pub. No.: US 2008/0248390 A1
(43) Pub. Date: Oct. 9, 2008

(54) Non-aqueous electrolyte secondary battery

(76) Inventors: Chihiro Yada, Osaka (JP); Noriyuki Shimizu, Sakura-shi (JP); Yoshinori Kida, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/076,769

(22) Filed: Mar. 21, 2008

(30) Foreign Application Priority Data
Mar. 23, 2007 (JP) 2007-076211

(51) Int. Cl. H01M 4/52; H01M 4/40

(52) U.S. Cl. 429/221; 429/231.95

(57) ABSTRACT

A non-aqueous electrolyte secondary battery includes: a positive electrode comprising a positive electrode active material capable of intercalating and deintercalating lithium ions; a negative electrode; and a non-aqueous electrolyte. The positive electrode active material contains Li_{b}FePO₄, where 0≦b<1, and a layered lithium-containing metal oxide represented by the general formula LiₓCo_{y}M_{z}O₂, where M is at least one element selected from the group consisting of Na, K, B, F, Mg, Al, Ti, V, Cr, Mn, Fe, Ni, Cu, Zn, Nb, Mo, Zr, Sn, and W, and where x, y, and z satisfy the conditions 1≦x<1.3, 0<y≦1, and 0≦z<1.

### BACKGROUND OF THE INVENTION

1. Field of the Invention

The present invention relates to a non-aqueous electrolyte secondary battery comprising a positive electrode capable of intercalating and deintercalating lithium ions, a negative electrode, and a non-aqueous electrolyte. More particularly, the invention relates to a non-aqueous electrolyte secondary battery employing a lithium-containing metal oxide containing at least cobalt as a positive electrode active material in the positive electrode, wherein abrupt resistance increase of the positive electrode active material at a late stage of discharge is prevented so that high power can be obtained over a wide charge-discharge region.

2. Description of Related Art

In recent years, non-aqueous electrolyte secondary batteries have been widely in use as a new type of high power, high energy density secondary battery. Non-aqueous electrolyte secondary batteries typically use a non-aqueous electrolyte and perform charge-discharge operations by transferring lithium ions between the positive electrode and the negative electrode.

In the non-aqueous electrolyte secondary batteries, lithium cobalt oxide LiCoO₂ having a layered structure, which is excellent in stability and charge-discharge characteristics, is commonly used as a positive electrode active material in the positive electrode.

However, there have been some problems with this type of non-aqueous electrolyte secondary battery. For example, because cobalt used for the lithium cobalt oxide material is a scarce natural resource, the manufacturing cost is high and the supply tends to be unstable.

For these reasons, use of lithium nickel oxide or lithium nickel manganese oxide, which uses nickel or manganese in place of cobalt, has been investigated to obtain an inexpensive positive electrode active material that enables stable supply.

The positive electrode active materials that do not contain cobalt, such as lithium nickel oxide and lithium nickel manganese oxide, however, have the problems of low chemically stability and poor durability.

In view of such problems, various proposals have been made. For example, Japanese Published Unexamined Patent Application No. 2002-110165 proposes a positive electrode active material in which part of nickel in lithium nickel oxide is substituted by cobalt or the like to improve chemical stability of the positive electrode active material. Japanese Published Unexamined Patent Application No. 2003-221236 proposes a positive electrode active material in which part of lithium nickel manganese oxide is substituted by cobalt or the like to improve durability of the positive electrode active material.

A problem in the use of lithium cobalt oxide and the just-mentioned lithium-containing metal oxides that contain cobalt, in which part of the nickel or manganese is substituted by cobalt, as a positive electrode active material is that the resistance of the positive electrode active material abruptly increases at the end of discharge of the battery. This makes it difficult to obtain a high power over a wide charge-discharge region when using the battery for high-power applications, such as the power source for hybrid automobiles.

### BRIEF SUMMARY OF THE INVENTION

It is an object of the present invention to solve the foregoing and other problems in such a non-aqueous electrolyte secondary battery that employs a lithium-containing metal oxide containing at least cobalt as a positive electrode active material in the positive electrode, the battery comprising a positive electrode containing a positive electrode active material capable of intercalating and deintercalating lithium ions, a negative electrode, and a non-aqueous electrolyte.

In other words, it is an object of the present invention to prevent, in a non-aqueous electrolyte secondary battery that employs a lithium-containing metal oxide containing at least cobalt as a positive electrode active material, an abrupt increase in the resistance of the positive electrode active material and to obtain a high power over a wide charge-discharge region.

In order to solve the foregoing and other problems, the non-aqueous electrolyte secondary battery according to the present invention comprises, as described above, a positive electrode comprising a positive electrode active material capable of intercalating and deintercalating lithium ions, a negative electrode, and a non-aqueous electrolyte, and the positive electrode active material contains Li_{b}FePO₄, where 0≦b<1, and a layered lithium-containing metal oxide represented by the general formula LiₓCo_{y}M_{z}O₂, where M is at least one element selected from the group consisting of Na, K, B, F, Mg, Al, Ti, V, Cr, Mn, Fe, Ni, Cu, Zn, Nb, Mo, Zr, Sn, and W, and where x, y, and z satisfy the conditions 1≦x<1.3, 0<y≦1, and 0≦z<1.

Here, FePO₄ exists in the Li_{b}FePO₄, where 0≦b<1. Thus, it is believed that when such a lithium-containing metal oxide containing cobalt as described above and the Li_{b}FePO₄, where 0≦b<1, are mixed together, lithium ions are easily accepted into the positive electrode active material at the end of discharge due to the electrochemical actions between the cobalt ions contained in the lithium-containing metal oxide and the iron ions contained in the FePO₄. As a result, an abrupt increase of the resistance of the positive electrode active material at the end of discharge is prevented.

In the non-aqueous electrolyte secondary battery, if the amount of Li_{b}FePO₄ in the positive electrode active material is too large, the relative amount of the lithium-containing metal oxide represented by the above-described general formula becomes small, and the charge-discharge capacity of the positive electrode accordingly degrades. Therefore, it is preferable that the amount of Li_{b}FePO₄ in the positive electrode active material be 10 weight % or less.

As described above, in the non-aqueous electrolyte secondary battery according to the present invention, the positive electrode active material contains Li_{b}FePO₄, where 0≦b<1, and a layered lithium-containing metal oxide represented by the general formula LiₓCo_{y}M_{z}O₂, where M is at least one element selected from the group consisting of Na, K, B, F, Mg, Al, Ti, V, Cr, Mn, Fe, Ni, Cu, Zn, Nb, Mo, Zr, Sn, and W, and where x, y, and z satisfy the conditions 1≦x<1.3, 0<y≦1, and 0≦z<1. Therefore, the capability of the positive electrode active material to accept lithium ions at the end of discharge improves, preventing the resistance of the positive electrode active material from abruptly increasing at the end of discharge.

As a result, the non-aqueous electrolyte secondary battery according to the present invention makes it possible to obtain high power over a wide charge-discharge region and to enable use in high power applications such as a power source for hybrid automobiles.

### BRIEF DESCRIPTION OF THE DRAWINGS

FIG. 1 is a schematic illustrative drawing of a three-electrode test cell using, as the working electrode, a positive electrode fabricated according to Examples 1 through 7 according to the present invention and Comparative Examples 1 through 8.

### DETAILED DESCRIPTION OF THE INVENTION

Hereinbelow, preferred embodiments of the non-aqueous electrolyte secondary battery according to the present invention are described in further detail.

The non-aqueous electrolyte secondary battery according to the present invention comprises, as described above, a positive electrode comprising a positive electrode active material capable of intercalating and deintercalating lithium ions, a negative electrode, and a non-aqueous electrolyte, and the positive electrode active material contains Li_{b}FePO₄, where 0≦b<1, and a layered lithium-containing metal oxide represented by the general formula LiₓCo_{y}M_{z}O₂, where M is at least one element selected from the group consisting of Na, K, B, F, Mg, Al, Ti, V, Cr, Mn, Fe, Ni, Cu, Zn, Nb, Mo, Zr, Sn, and W, and where x, y, and z satisfy the conditions 1≦x<1.3, 0<y≦1, and 0≦z<1.

The lithium-containing metal oxide containing cobalt and represented by the foregoing general formula, which is used for the positive electrode active material, may be a lithium cobalt oxide LiCoO₂, where y in the formula is 1. That said, since cobalt is a scarce natural resource, as mentioned above, the use of cobalt may lead to high manufacturing costs and unstable supply. For this reason, it is preferable that the lithium-containing metal oxide represented by the foregoing general formula be one wherein y in the formula is 1, and M is Ni, Mn, or the like.

It is preferable that the Li_{b}FePO₄ belongs to the space group Pnma, from the viewpoint of improving the energy density of the battery.

The non-aqueous electrolyte secondary battery according to the present invention is characterized in that it employs the positive electrode active material as set forth above, so the rest of the parts of the battery may be configured like conventional non-aqueous electrolyte secondary batteries.

In the non-aqueous electrolyte secondary battery, the negative electrode active material used for the negative electrode may be any known commonly-used material. From the viewpoint of improving the energy density of the battery, it is desirable to use a material with a relatively low potential of the charge-discharge reaction, such as metallic lithium, a lithium alloy, and carbon materials such as graphite.

The non-aqueous electrolyte may be a commonly used non-aqueous electrolyte in which an electrolyte salt is dissolved in a non-aqueous solvent.

The non-aqueous solvent may be a commonly used solvent, and examples include cyclic carbonic esters, chain carbonic esters, esters, cyclic ethers, chain ethers, nitrites, amides, and combinations thereof.

Examples of the cyclic carbonic esters include ethylene carbonate, propylene carbonate and butylene carbonate. It is also possible to use a cyclic carbonic ester in which part or all of the hydrogen groups of the just-mentioned cyclic carbonic esters is/are fluorinated, such as trifluoropropylene carbonate and fluoroethyl carbonate.

Examples of the chain carbonic esters include dimethyl carbonate, diethyl carbonate, ethyl methyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, and examples of the amides include dimethylformamide.

Examples of the electrolyte salt to be dissolved in the non-aqueous solvent include LiPF₆, LiBF₄, LiCF₃SO₃, LiC₄F₉SO₃, LiN(CF₃SO₂)₂, LiN(C₂F₅SO₂)₂, LiAsF₆, LiN(CF₃SO₂)(C₄F₉SO₂), LiC(CF₃SO₂)₃, LiC(C₂F₅SO₂)₃, LiClO₄, Li₂B₁₀Cl₁₀, LiB(C₂O₄)₂, LiB(C₂O₄)F₂, LiP(C₂O₄)₃, LiP(C₂O₄)₂F₂, Li₂B₁₂Cl₁₂, and mixtures thereof.

From the viewpoint of improving the cycle performance of the battery, it is preferable to add a lithium salt having an oxalato complex as anions, more preferably lithium-bis(oxalato)borate, to the electrolyte salt.

### EXAMPLES

Hereinbelow, examples of the non-aqueous electrolyte secondary battery according to the present invention will be described in detail along with comparative examples, and it will be demonstrated that the resistance of the positive electrode active material is reduced in the examples of the non-aqueous electrolyte secondary battery according to the invention. It should be construed, however, that the non-aqueous electrolyte secondary battery according to the present invention is not limited to the following examples, but various changes and modifications are possible without departing from the scope of the invention.

### Example 1

In Example 1, a positive electrode was prepared using LiNi_{0.80}Co_{0.15}Al_{0.05}O₂ as the lithium-containing metal oxide containing cobalt and represented by the foregoing general formula. The LiNi_{0.80}Co_{0.15}Al_{0.05}O₂ was prepared by mixing Li₂CO₃ and a hydroxide of Ni_{0.80}Co_{0.15}Al_{0.05} together and sintering the mixture in air at 900° C.

FePO₄ belonging to the space group Pnma, which was obtained by delithiation from LiFePO₄, was used as the Li_{b}FePO₄.

The just-described LiNi_{0.80}Co_{0.15}Al_{0.05}O₂ and FePO₄ were mixed together at a weight ratio of 95:5, and the resultant mixture was used as the positive electrode active material. The positive electrode active material, a carbon material as a conductive agent, and polyvinylidene fluoride as a binder agent were dissolved in a N-methyl-2-pyrrolidone solution so that the positive electrode active material, the conductive agent, and the binder agent were in a weight ratio of 90:5:5, and the resultant was kneaded to prepare a positive electrode mixture slurry. Then, the positive electrode mixture slurry was applied onto a current collector made of an aluminum foil and then dried. Thereafter, the resultant material was pressure-rolled using pressure rollers and thereafter cut into a predetermined size. Thus, a positive electrode was prepared.

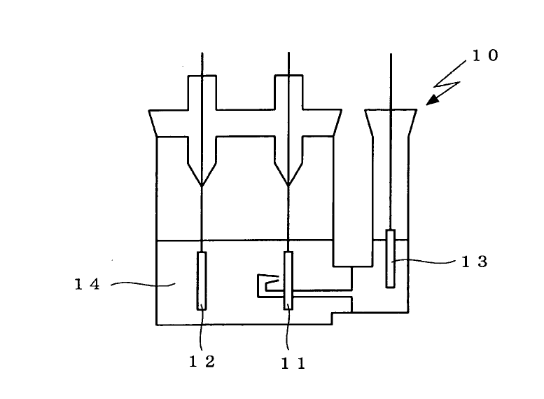

Then, a three-electrode test cell 10 as illustrated in FIG. 1 was prepared using the following components. The positive electrode prepared in the above-described manner was used as the working electrode 11. Metallic lithium was used for the counter electrode 12 and for the reference electrode 13. Lithium hexafluorophosphate (LiPF₆) was dissolved at a concentration of 1 mol/L into a mixed solvent of ethylene carbonate, ethyl methyl carbonate, and dimethyl carbonate in a volume ratio of 4:3:3, to prepare the non-aqueous electrolyte solution 14.

### Example 2

In Example 2, a positive electrode was prepared in the same manner described as in Example 1 above, except that the positive electrode active material used was a mixture of the same LiNi_{0.80}Co_{0.15}Al_{0.05}O₂ and FePO₄ as used in Example 1 above in a weight ratio of 90:10. Using the prepared positive electrode, a three-electrode test cell was prepared in the same manner as described in Example 1 above.

### Comparative Example 1

In Comparative Example 1, a positive electrode was prepared in the same manner as described in Example 1 above, except that the positive electrode active material used was LiNi_{0.80}Co_{0.15}Al_{0.05}O₂ alone. Using the prepared positive electrode, a three-electrode test cell was prepared in the same manner as described in Example 1 above.

### Comparative Example 2

In Comparative Example 2, a positive electrode was prepared in the same manner as described in Example 1 above, except that the positive electrode active material used was FePO₄ alone. Using the prepared positive electrode, a three-electrode test cell was prepared in the same manner as described in Example 1 above.

### Example 3

In Example 3, Li_{1.01}Ni_{0.40}Co_{0.30}Mn_{0.30}O₂ was used as the lithium-containing metal oxide represented by the foregoing general formula and containing cobalt, and the Li_{1.01}Ni_{0.40}Co_{0.30}Mn_{0.30}O₂ and FePO₄ were mixed in a weight ratio of 90:10 to prepare a positive electrode active material. Except for using the positive electrode active material thus prepared, a positive electrode and a three-electrode test cell were prepared in the same manner as described in Example 1 above.

### Comparative Example 3

In Comparative Example 3, a positive electrode was prepared in the same manner as described in Example 1 above, except that the positive electrode active material used was Li_{1.01}Ni_{0.40}Co_{0.30}Mn_{0.30}O₂, as used in Example 3 above, alone. Using the prepared positive electrode, a three-electrode test cell was prepared in the same manner as described in Example 1 above.

### Example 4

In Example 4, LiCoO₂ was used as the lithium-containing metal oxide represented by the foregoing general formula and containing cobalt, and the LiCoO₂ and FePO₄ were mixed in a weight ratio of 90:10 to prepare a positive electrode active material. Except for using the positive electrode active material thus prepared, a positive electrode and a three-electrode test cell were prepared in the same manner as described in Example 1 above.

### Comparative Example 4

In Comparative Example 4, a positive electrode was prepared in the same manner as described in Example 1 above, except that the positive electrode active material used was LiCoO₂, as used in Example 4 above, alone. Using the prepared positive electrode, a three-electrode test cell was prepared in the same manner as described in Example 1 above.

### Comparative Example 5

In Comparative Example 5, a positive electrode was prepared in the same manner described as in Example 1 above, except that the positive electrode active material used was a mixture of Li_{1.08}Ni_{0.46}Mn_{0.46}O₂, which is a lithium-containing metal oxide not containing cobalt, and the FePO₄ in a weight ratio of 90:10. Using the prepared positive electrode, a three-electrode test cell was prepared in the same manner as described in Example 1 above.

### Comparative Example 6

In Comparative Example 6, a positive electrode was prepared in the same manner as described in Example 1 above, except that the positive electrode active material used was Li_{1.08}Ni_{0.46}Mn_{0.46}O₂, as used in Comparative Example 5, alone. Using the prepared positive electrode, a three-electrode test cell was prepared in the same manner as described in Example 1 above.

### Comparative Example 7

In Comparative Example 7, a positive electrode was prepared in the same manner described as in Example 1 above, except that the positive electrode active material used was a mixture of Li_{1.1}Mn_{1.9}O₂, which is a lithium-containing metal oxide not containing cobalt, and the FePO₄ in a weight ratio of 90:10. Using the prepared positive electrode, a three-electrode test cell was prepared in the same manner as described in Example 1 above.

### Comparative Example 8

In Comparative Example 8, a positive electrode was prepared in the same manner as described in Example 1 above, except that the positive electrode active material used was Li_{1.1}Mn_{1.9}O₂, as used in Comparative Example 7, alone. Using the prepared positive electrode, a three-electrode test cell was prepared in the same manner as described in Example 1 above.

Next, using the three-electrode test cells of Examples 1 through 4 and Comparative Examples 1 through 8 prepared in the above-described manners, each cell was discharged at a discharge current density of 0.75 mA/cm² to an end-of-discharge voltage of 2.5 V (vs. Li/Li⁺), and thereafter rested for 10 minutes, to measure the open circuit voltage of each cell.

Thereafter, each of the three-electrode test cells was discharged from the open circuit voltage state at discharge current densities of 0.08 mA/cm², 0.4 mA/cm², 0.8 mA/cm², and 1.6 mA/cm² for 10 seconds each time, and the battery voltage (vs. Li/Li⁺) 10 seconds after each discharge was obtained for each cell. Then, the battery voltages at the respective current values were plotted to obtain the I-V profile, and from the gradient of the graph obtained, the I-V resistance at the end of discharge was determined for each of the three-electrode test cells. The results are shown in Table 1 below.

TABLE 1

| | | I-V resistance |
|---|---|---|
| | | at the end |
| | Positive electrode active | of discharge |
| | material and weight ratio | (Ω) |
| Example 1 | LiNi_{0.80}Co_{0.15}Al_{0.05}O₂:FePO₄ = 95:5 | 16.8 |
| Example 2 | LiNi_{0.80}Co_{0.15}Al_{0.05}O₂:FePO₄ = 90:10 | 10.7 |
| Comparative | LiNi_{0.80}Co_{0.15}Al_{0.05}O₂ | 23.1 |
| Example 1 | | |
| Comparative | FePO₄ | 21.5 |
| Example 2 | | |
| Example 3 | Li_{1.01}Ni_{0.40}Co_{0.30}Mn_{0.30}O₂:FePO₄ = 90:10 | 15.8 |
| Comparative | Li_{1.01}Ni_{0.40}Co_{0.30}Mn_{0.30}O₂ | 30.8 |
| Example 3 | | |
| Example 4 | LiCoO₂:FePO₄ = 90:10 | 21.0 |
| Comparative | LiCoO₂ | 57.7 |
| Example 4 | | |
| Comparative | Li_{1.08}Ni_{0.46}Mn_{0.46}O₂:FePO₄ = 90:10 | 26.8 |
| Example 5 | | |
| Comparative | Li_{1.08}Ni_{0.46}Mn_{0.46}O₂ | 19.2 |
| Example 6 | | |
| Comparative | Li_{1.1}Mn_{1.9}O₂:FePO₄ = 90:10 | 16.8 |
| Example 7 | | |
| Comparative | Li_{1.1}Mn_{1.9}O₂ | 15.9 |
| Example 8 | | |

The results demonstrate the following. The cells of Examples 1 through 4 employed, as the positive electrode active material, FePO₄ and a lithium-containing metal oxide containing cobalt and represented by the foregoing general formula. Each of the cells of Examples 1 through 4 exhibited a significantly lower I-V resistance at the end of discharge than that of Comparative Examples 1, 3 and 4, which contain no FePO₄, and they also exhibited a lower I-V resistance at the end of discharge than Comparative Example 2, which uses FePO₄ alone as the positive electrode active material.

In the cells of Comparative Examples 5 through 8, which employed a lithium-containing metal oxide not containing cobalt, the addition of FePO₄ conversely resulted in a greater I-V resistance at the end of discharge, and the addition of FePO₄ did not produce the advantageous effect of significantly lowering the I-V resistance at the end of discharge, unlike the cells of the present invention, which used a lithium-containing metal oxide represented by the foregoing formula and containing cobalt.

### Example 5

In Example 5, the same LiNi_{0.80}Co_{0.15}Al_{0.05}O₂ as used in Example 1 above was used as the lithium-containing metal oxide represented by the foregoing general formula and containing cobalt, but Li_{0.25}FePO₄ was used as the Li_{b}FePO₄. The LiNi_{0.80}Co_{0.15}Al_{0.05}O₂ and the Li_{0.25}FePO₄ were mixed in a weight ratio of 90:10 to prepare a positive electrode active material. Except for using the positive electrode active material thus prepared, a positive electrode and a three-electrode test cell were prepared in the same manner as described in Example 1 above.

### Example 6

In Example 6, the same LiNi_{0.80}Co_{0.15}Al_{0.05}O₂ as used in Example 1 above was used as the lithium-containing metal oxide represented by the foregoing general formula and containing cobalt, but Li_{0.50}FePO₄ was used as the Li_{b}FePO₄. The LiNi_{0.80}Co_{0.15}Al_{0.05}O₂ and the Li_{0.50}FePO₄ were mixed in a weight ratio of 90:10 to prepare a positive electrode active material. Except for using the positive electrode active material thus prepared, a positive electrode and a three-electrode test cell were prepared in the same manner as described in Example 1 above.

### Example 7

In Example 7, the same LiNi_{0.80}Co_{0.15}Al_{0.05}O₂ as used in Example 1 above was used as the lithium-containing metal oxide represented by the foregoing general formula and containing cobalt, but Li_{0.75}FePO₄ was used as the Li_{b}FePO₄. The LiNi_{0.80}Co_{0.15}Al_{0.05}O₂ and the Li_{0.75}FePO₄ were mixed in a weight ratio of 90:10 to prepare a positive electrode active material. Except for using the positive electrode active material thus prepared, a positive electrode and a three-electrode test cell were prepared in the same manner as described in Example 1 above.

For the three-electrode test cells of Examples 5 through 7 prepared in the above-described manners, the I-V resistance at the end of discharge was obtained in the same manner as described previously. The results are shown in Table 2 below.

TABLE 2

| | | I-V resistance |
|---|---|---|
| | | at the end |
| | Positive electrode active | of discharge |
| | material and weight ratio | (Ω) |
| Example 5 | LiNi_{0.80}Co_{0.15}Al_{0.05}O₂:Li_{0.25}FePO₄ = 90:10 | 8.5 |
| Example 6 | LiNi_{0.80}Co_{0.15}Al_{0.05}O₂:Li_{0.50}FePO₄ = 90:10 | 10.3 |
| Example 7 | LiNi_{0.80}Co_{0.15}Al_{0.05}O₂:Li_{0.75}FePO₄ = 90:10 | 8.5 |

The results demonstrate the following. The test cells of Examples 5 through 7 employ LiNi_{0.80}Co_{0.15}Al_{0.05}O₂, which is a positive electrode active material comprising a lithium-containing metal oxide containing cobalt and represented by the foregoing general formula, as well as Li_{0.25}FePO₄, Li_{0.50}FePO₄, and Li_{0.75}FePO₄, respectively, in which b in the formula Li_{b}FePO₄ satisfies the condition 0≦b<1. In the test cells of Examples 5 through 7 as well, the I-V resistance at the end of discharge was significantly lower than that of Comparative Example 1.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2007-076211 filed Mar. 23, 2007, which is incorporated herein by reference.

What is claimed is:

1. A non-aqueous electrolyte secondary battery comprising: a positive electrode comprising a positive electrode active material capable of intercalating and deintercalating lithium ions; a negative electrode; and a non-aqueous electrolyte, wherein the positive electrode active material contains Li_{b}FePO₄, where 0≦b<1, and a layered lithium-containing metal oxide represented by the general formula LiₓCo_{y}M_{z}O₂, where M is at least one element selected from the group consisting of Na, K, B, F, Mg, Al, Ti, V, Cr, Mn, Fe, Ni, Cu, Zn, Nb, Mo, Zr, Sn, and W, and where x, y, and z satisfy the conditions 1≦x<1.3, 0<y≦1, and 0≦z<1.

2. The non-aqueous electrolyte secondary battery according to claim 1, wherein, in the positive electrode active material, the amount of the Li_{b}FePO₄ is 10 weight % or less.
